(19) United States
(12) Patent Application Publication
(10) Pub. No.: US 2015/0088629 A1
(43) Pub. Date: Mar. 26, 2015

(54) SYSTEM AND METHODS FOR GENERATING AND PROVIDING OFFERS TO A USER

(71) Applicant: MATCH.COM, L.L.C., Dallas, TX (US)

(72) Inventors: Sharmistha Dubey, Coppell, TX (US); James Nathaniel Talbott, Deep River, CT (US); Sydney C. Lam, Dallas, TX (US)

(73) Assignee: MATCH.COM, L.L.C., Dallas, TX (US)

(21) Appl. No.: 14/035,094

(22) Filed: Sep. 24, 2013

(51) Int. Cl. G06Q 30/02; G06Q 20/12

(52) U.S. Cl. CPC G06Q 30/0222; G06Q 20/12
USPC 705/14.23

(57) ABSTRACT

Methods and systems for providing offers to a user through a user interface are disclosed. A first offer having a first price to a user through the user interface is provided. A user input indicating an acceptance to the first offer through the user interface is received. A request is transmitted to a payment processor to process a payment from a payment account of the user for the first price. A message from the payment processor in response to the request that the first request cannot be completed is received. A first message is processed to generate a second offer having a second price, wherein the second price is lower than the first price. The second offer to the user through the user interface.

### TECHNICAL FIELD

This disclosure relates in general to the field of electronic commerce and, more particularly, to a system and a method for generating and providing offers to a user in electronic commerce.

### BACKGROUND

Electronic commerce (e-commerce) offer convenient and effective access for end users to a large range of services and products. For instance, shopping websites or applications allow users to purchase virtually anything imaginable, from clothing to travel experiences. In some instances, e-commerce platforms allow users to purchase access or subscription to a service, such as memberships for online dating websites, credit for gambling websites or games, etc. Much of e-commerce is driven by electronic payment transactions, where end users are able to pay for services and products simply by providing payment account information to the website or application. Sometimes through a little as one click, the end user is able to submit a request to authorize a charge to his or her account to make a purchase.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a network diagram showing an operating environment of the present disclosure, according to some embodiments of the disclosure;

FIGS. 2A-C are simplified screen shots of an example protocol for generating and providing offer(s) to a user, according to some embodiments of the disclosure;

FIG. 3 shows a simplified screen shot from another example protocol for generating and providing offer(s) to a user, according to some embodiments of the disclosure;

FIG. 4 is a system diagram showing an illustrative system configured generate and provide offers(s), according to some embodiments of the disclosure;

FIG. 5 is a flow diagram illustrating a method or logic implemented by an offer engine, according to some embodiments of the disclosure; and

FIG. 6 is a flow diagram illustrating a method or logic implemented by the server, according to some embodiments of the disclosure.

### DETAILED DESCRIPTION OF EXAMPLE EMBODIMENTS

### Overview

Methods and systems for providing offers to a user through a user interface are disclosed. The methods and systems disclosed herein leverages messages from a payment processor, in particular, error codes in these messages, to generate further offers to a user. Even though a payment request may not be processed successfully, generating further offers captures the opportunity that another payment request might be successful if the other payment request is made for a lower price.

An application may provide a first offer having a first price to a user through the user interface. Then, a first user input indicating an acceptance to the first offer is received through the user interface. In response, the application may transmit a first request to a payment processor to process a first payment from a payment account of the user for the first price. The payment processor may, in response, transmit a first message to the application indicating that the first request cannot be completed, and the application receives the first message from the payment processor. An offer engine may be provided to process the first message to generate a second offer having a second price, wherein the second price is lower than the first price. The second offer is then provided to the user through the user interface.

In some embodiments, the offer engine may generate the second offer only after the user has attempted to process the payment but failed for the second time, third time, or fourth time, and so on (i.e., further request(s) for payment to purchase the second offer are sent and the payment processor transmits further message(s) indicating further request(s) for payment cannot be completed). This provides a buffer to allow the user to attempt to make a payment again for the same offer having the same price before an offer with a lower price is generated.

In some embodiments, further offer(s) may be successively generated if payment request(s) continues to be unsuccessful. A second user input indicating an acceptance to the second offer is received through the user interface. Then the application may transmit a second request to a payment processor to process a second payment from the payment account of the user for the second price. The application may receive a second message from the payment processor in response to the second request that the second request cannot be completed. The offer engine may then process the second message to generate a third offer having a second price, wherein the third price is lower than the first price and the second price. The application may provide the third offer to the user through the user interface.

The successive process may continue until a condition is met, e.g., no further offers having a lower price is available, or a certain maximum number of iterations has been performed. In some embodiments, the successive process of generating further offers may depend on other factors such as user profile information, or the number of times an error message has been received from the payment processor.

In some embodiments, the application and/or the offer engine may capture an opportunity to provide a higher priced offer to prompt the user to make a purchase with a higher price before the prices for further offers decrease. Prior to transmitting the first payment request to the payment processor, the application may prompt the user with a third offer having a third price through the user interface, wherein the third price is higher than the first price. The application may receive a third user input through the user interface in response to the third offer. If the third user input indicates an acceptance to the third offer, the application may transmitting the first payment request to the payment processor for the third price instead of the first price. If the third user input indicates a refusal to the third offer, continue with the step of transmitting the first payment request to the payment processor for the first price.

The proposed methods and systems for providing further offers at a lower price may be particularly suitable for platforms which offers subscriptions to a service to its end users. Subscriptions are typically defined by its duration. If the payment request for the first offer cannot be completed, another offer having a subscription with a shorter duration may be generated and provided to the user. For instance, the first offer may comprise a first subscription for a first duration. The second offer may comprise a second subscription for a second duration, wherein the second duration is shorter than the first duration. In another instance, the first offer is a bundle comprising a first subscription for a first duration and one or more add-on products and the second offer comprises a second subscription for a second duration and no add-on products, wherein the second duration is shorter than the first duration.

One way of leveraging the messages from the payment processor is to process the error codes provided in the messages. In some cases, the messages from the payment processor in response to payment requests may indicate insufficient funds in the payment account. Specifically, some messages may include an error code corresponding to a “do not honor” or a “credit floor” message, which may indicate there is insufficient funds/credit in the payment account of the user.

The messages from the payment processor may be processed in several ways. For instance, an offer engine may receive or extract an error code from the first message. Using, e.g., a look-up table, the offer engine may determine whether the error code indicates insufficient funds in the payment account, wherein the look-up table comprises error codes with corresponding indicators indicating whether an error code indicates insufficient funds. Accordingly, the offer engine may generate the second offer having the lower price if the error code indicates insufficient funds in the payment account.

### Example Embodiments

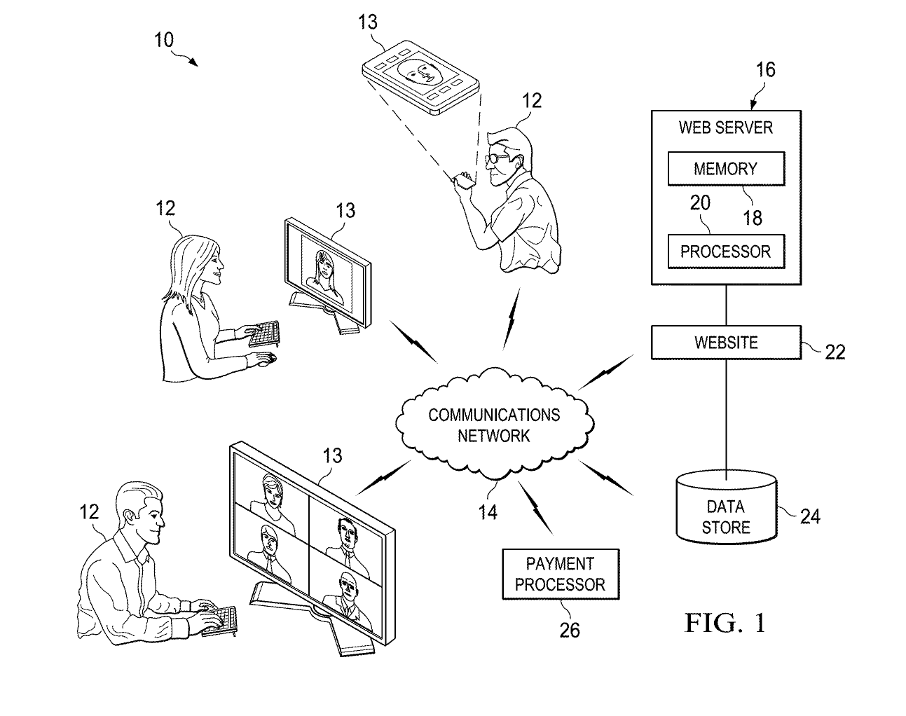

FIG. 1 is a network diagram showing an operating environment of the present disclosure, in accordance with some embodiments of the present disclosure. To illustrate the operating environment, FIG. 1 shows a simplified block diagram of an exemplary system 10 for providing a service in a network environment. In particular, the exemplary system 10 offers, e.g., an online dating service to end users who have purchased a subscription. Although the present disclosure is described in the context of an online dating service, the disclosure is applicable to other platforms (e.g., electronic commerce or “e-commerce” platforms) for offering products and/or services to end users. The embodiments disclosed herein are particularly applicable to platforms which offer the sale of products and/or services having different prices. A few examples of such platforms include, job searching platforms, professional networking platforms, online shopping websites, online communities, gaming applications/platforms, gambling applications/platforms, etc. Further examples of products/services may include database subscriptions (e.g., technical journals, legal court services, etc.), health club memberships, financial subscriptions (for market research and data feeds). Other illustrative platforms may include book and media sales platforms where products may have a variety of tiers or products may be provided in a variety of forms (e.g., e-book, audio book, hardcover, softcover, collector's edition) where pricing may differ.

FIG. 1 includes multiple end users 12 and endpoints 13, a communications network 14, a (web) server 16 comprising memory 18 and at least one processor 20, a website 22 (or in some embodiments, an application), and a data store 24 (also referred to as “storage” or “computer-readable non-transient memory” in some embodiments). Data store 24 may be any type of mechanism for storing data, including but not limited to one or more files, databases, memory devices, mass storage devices, data centers, etc. In system 10, users 12 interact with web server 16 via endpoints 13, each of which comprises an appropriate user interface for interacting with web server 16 via website 22 for facilitating functions and features described herein. End users 12 may include a variety of types of end users, such as clients, customers, prospective customers, customer care agents, or entities wishing to participate, e.g., in an online dating service, to view information associated with other participants in the system, to access any services provided by the platform. Generally, web server 16 is configured to provide output for the end user to consume at the end point through the user interface. In certain example implementations, website 22 and web server 16 are consolidated into a single component, physical structure, equipment, etc. FIG. 1 may be configured such that inter- and intra-communications are readily achieved by any of the components included therein.

Note that the broad term “user” or “end user” encompasses any type of node or user device, or any type of endpoint discussed herein. Additionally, the term “user” or “end user” can further include any type of profile to be used in the system discussed herein. Hence, the term “user” or “end user” can include (but is not limited to) user equipment elements such as a computer, a personal digital assistant (PDA), a laptop or electronic notebook, a cellular telephone, an IP telephone, an iPhone™, an ‘Pad’, a Microsoft Surface™, an Android™ phone, a Google Nexus', or any other device, component, element, or object capable of initiating voice, audio, or data exchanges within communication system 10. The endpoints may be inclusive of a suitable interface to the end user 12, such as a microphone, a display, or a keyboard or other terminal equipment. Endpoints 13 may also include any device that seeks to initiate a communication on behalf of another entity or element, such as a program, a database, or any other component, device, element, or object capable of initiating a voice or a data exchange within communication system 10. In addition, each of the endpoints 13 may be a unique element designed specifically for communications involving system 10. Such an element may be fabricated or produced specifically for applications disclosed herein involving end user 12 and endpoint 13.

A user may employ any user equipment device capable of operating as an endpoint 13 to connect to communications network 14 via wire, wireless, cellular, satellite link or other suitable interfaces. Web server 16, which as previously noted includes memory 18 and at least one processor 20, hosts website 22. Web server 16 has access to transmit and receive user or presence data (e.g., user profile data/information, user and/or user endpoint data, user contact data, etc.) from database 24. Presence data may be collected, aggregated, and utilized as required to facilitate communications between endpoints 12 over communications network 10 or other outside communication systems. Presence data may also include information and/or instructions enabling the creation, duration, and termination of communication sessions between diverse endpoints 13 that utilize different communication and/or networking protocols.

Communications network 14 is a communicative platform operable to exchange data or information emanating from endpoints 13. Communications network 14 represents an Internet architecture in a particular embodiment of the present disclosure, which provides end users 12 with the ability, e.g., to electronically execute or to initiate user actions, e.g., actions associated with finding a potential match candidate. Alternatively, communications network 14 could be a plain old telephone system (POTS), which end user 12 could use to perform the same operations or functions. In some embodiments, communications network may be a mobile phone (cellular) network, which end user 12 could use to perform the same operations or functions via a user interface which uses, e.g., Short Message Service (SMS) messages, Multimedia Messaging Service (MMS) messages, etc. Such transactions may be assisted by management associated with website 22 and/or manually keyed into a telephone or other suitable electronic equipment. In other embodiments, communications network 14 could be any packet data network (PDN) offering a communications interface or exchange between any two nodes in system 10. Communications network 14 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

In one embodiment, web server 16 comprises a computer server that is operable to receive and to communicate information to one or more end users 12. In the case of an online matching service, (web) server 16 can implement a computer-implemented matching system that provides a framework/platform for suitable matching activities. Alternatively, web server 16 may be any switch, router, gateway, cache, server blade, software, processor, proprietary component, object, module, or element (or any combination of these) operable to facilitate communications involving end user 12. Web server 16 may be integrated with database 24 and/or website 22, where any one or more of these elements may share or otherwise coordinate the activities discussed herein.

In one particular embodiment, web server 16, via interaction with database 24 and/or in conjunction with website 22, provides a service in facilitating interaction(s) between parties interested in seeking a romantic partner (i.e., in an online dating scenario). For example, website 22 can be online dating service provider www.Match.com, www.Chemistry.com, or any other suitable provider. In certain embodiments, website 22 (or one or more applications) is a computer-implemented matching system, which may be any website or architecture provided for selling products and/or services. In some instances, the website may facilitating a connection involving two or more people, and which may make use of a given profile, photograph, resume, article description, etc. This could include services associated with job placements, escort services, auction services, social media, real estate listings, recruiting services (e.g., in athletics, academia, employment scenarios, instances involving the sales of goods and services), etc.

Considerable flexibility is provided by the structure of web server 16 and website 22 in the context of system 10. Thus, it can be easily appreciated that such functions could be provided external to web server 16 or website 22. In such cases, such a functionality could be readily embodied in a separate component, application, server, processor, device, or module. Note that these features and capabilities may be provided in just one of these elements, in both, or distributed across both of them. Hence, in certain embodiments, the operations may be consolidated in a single website, where no redirection is needed, nor performed for the user.

The structure of the web server 16 and the website 22 allows a user to access the platform through a website viewable at the end point using a web browser. In some embodiments, the platform may be readily provided using a standalone application running at the end point, without the use of a website or remote web server. In some embodiments, the platform may be provided using an application running at the end point to provide the user interface, and the application communicates with a remote web server for executing certain server-related functions. It is envisioned that other suitable client-server architectures and/or peer-to-peer architectures for facilitating the features of the platform are envisioned.

End users 12 may access the aforementioned data via endpoints 13, which may be inclusive of devices used perform various user activities through a user interface, e.g., logging in, viewing a profile, initiating a communication, receiving communications/information from the server through an email/phone/messaging application, playing games, making bets, providing user profile information, viewing offer(s), providing payment information, etc. As a subscriber to the platform, end users 12 has access to these exemplary features of the platform. In the case of an online dating platform, end users 12 may seek access or to initiate communications with other end users that may be delivered via communications network 14. In some instances, end users 12 may review data (such as user profiles, for example) associated with other users in order to make matching decisions or selections as part of the service provided by the platform. Data (or sometimes referred to as “information”) as used herein in this document, refers to any type of numeric, voice, video, or script data, or any other suitable information in any appropriate format that may be communicated from one point to another.

In the case of a gaming application/platform or a gambling application/platform, end users 12 may communicate with other end users through communications delivered via communications network 14. End users 12 may play games and/or make bets in a game either by themselves or with one or more other end users. An end user may purchase a subscription, virtual products/services, make bets in a game, and/or activate certain features of the platform using a digital currency, e.g., virtual funds associated with an end user's profile. The digital currency may be purchased using actual real-world currency, by making a payment for the virtual funds using real-world currency from, e.g., a bank account, credit card, or electronic payment account, etc. Alternatively, users may purchase a subscription, products/services, make bets in a game, and/or activate certain features of the platform simply by using real currency by purchasing any of the above directly using real-world currency from, e.g., a bank account, credit card, or electronic payment account, etc.

In the case of an online shopping platform, users may be offered a variety of products, services, bundle of products, bundle of services, and/or bundle of product(s) and service(s). Offers for any of the above may have different prices, where some are more expensive than others. For instance, a ticketing platform for selling tickets to events may offer tickets having different prices corresponding to different classes or seating. In another instance, an online shopping platform may offer computer packages having different prices, where computer machines having more sophisticated hardware are more expensive than computer machines having less sophisticated hardware. In yet another instance, an online book store may offer books in different formats having different prices.

In certain example scenarios, a given end user may pay a fee for a subscription-based service, e.g., to access the features of the platform and/or content stored on the platform. Additionally, certain end user fee structures may apply to different tiers of service, e.g., through add-on's, some of which may entitle an end user to enhanced features on website 22 (e.g., the ability to communicate more frequently with other users, additional matches being provided (potentially, more frequently) to an end user who paid the higher fee structure, the ability to store data, the ability to share data, the ability to upload additional information, the ability to target specific searches based on particular criteria, the ability to receive preferential positioning in the context of being matched to other users, the ability to perform video calls (e.g., Skype, etc.) with other users, the ability to perform audio calls with other users, etc.). A user may be offered a bundle comprising a subscription and one or more add-on's.

A user may purchase a subscription to use the online dating platform using funds from a payment account, such as funds from a bank account, digital currency from an electronic payment account, credit from a credit card account, credit from a merchant credit account, or any type of funds suitable for making a purchase for services and/or products. One example of a service available for purchase is a subscription to the platform, e.g., an online dating service. The subscription may be defined by its duration. For instance, a duration for a subscription: 1 day, 2 days, 3 days, 1 week, 2 weeks, 3 weeks, 1 month, 2 months, 3 months, 6 months, 9 months, 12 months, 1 year, 2 years, etc. One example of a product available for purchase is a bundle of digital currency, wherein the digital currency can be used to purchase virtual products and/or services provided by the platform. For instance, a user may purchase X amount of virtual currency (e.g., Linden dollars, virtual coins for a fish store, etc.) for use on the platform to purchase products and/or services.

In some embodiments, services and/or products offered to the user are associated with different prices, where some are more expensive than others. Through the user interface at end points 13, end users 12 may be provided with an offer to purchase a subscription for a service and/or a product. Upon receiving a user input indicating an acceptance to the offer, the application at the end points 13 and/or the (web) server 16 may submit a request for payment to a payment processor 26.

Typically, a payment processor is a third-party entity configured to process electronic payments and/or payment transactions. A request to process payment to purchase the product/service at the price offered may be transmitted to the payment processor, e.g., through communications network 14. The payment processor may be configured to receive payment information associated with a payment account of the user and an amount to be charged to the payment account (i.e., the price of the offer), and process the payment by determining whether the amount to be charged is authorized or not authorized. A payment processor may transmit a message in response to request to inform the platform whether the amount to be charged to the payment account is authorized. If the amount to be charged is authorized, the amount to be charged would be deducted from the payment account of the user and an account belonging to merchant running the platform would be credited with the amount (minus any service fees that the payment processor may charge for processing the payment). A payment processor may encompass any type of module, server, or platform for coordinating payments (e.g., e-commerce payment network, a credit card company (such as Visa, MasterCard, etc.), PayPal, digital wallets, Bitcoin, digital currency banking/management systems, etc.).

It was discovered that a significant portion of requests to process payment to the payment processor cannot be completed, where many of the messages from the payment processor sent in response to the requests indicates an error has occurred. For instance, the message from the payment processor may include one or more of the following error codes (exemplary corresponding description for the error code is also shown below):

| Code | Description |
|---|---|
| 530 | Do Not Honor |
| 302 | Credit Floor |
| 591 | Invalid CC Number |
| 303 | Processor Decline |
| 531 | CVV2 failure |
| 806 | Restraint |
| 502 | Lost/Stolen |
| 501 | Pickup |
| 606 | Invalid Transaction |
| 594 | Other error |
| 522 | Card is expired |
| 596 | Suspected fraud |
| 811 | Invalid CID |
| 201 | Invalid Account number |
| 401 | Call |
| 503 | Fraud Violation |
| 510 | Over frequency Limit |
| 825 | No account |
| 571 | Revocation of recurring authority |
| 602 | Invalid Institution |
| 307 | Auth Not Found |
| 607 | Invalid Amount |
| 301 | Issuer Unavailable |
| 813 | Invalid PIN |
| 233 | Invalid MOP |

It has further been discovered that some of these error messages may indicate different types of problems with the payment transaction or allows an inference to be made relating to the problem occurred with a particular payment transaction. It has been realized that such an indication may provide further information relating to why the request for payment cannot be completed. For instance, exemplary code 530 (or any other suitable code) corresponding to “Do Not Honor” and/or exemplary code 302 for “Credit Floor” may indicate that the payment account of the user has insufficient funds or credit (or generally referred to as having “insufficient funds”) to allow the amount to be charged to be authorized. In another instance, exemplary code 531 for “Invalid CVV2 failure” and exemplary code “Invalid CID” may indicate that the security code entered for the payment information was incorrect (but probably does not indicate that there is insufficient funds/credit in the payment account).

Such information gathered from a message indicating that the payment cannot be completed may be leveraged to generate another offer to the user such that the user is provided with another opportunity to make a purchase. For instance, if the message from the payment processor indicates there is insufficient funds in the payment account of the user, another offer may be generated wherein the other offer would have a lower price. For privacy/security reasons, the amount of funds or the amount of credit remaining in the payment account is not shared in the message from the payment processor. However, it is possible that the other offer with the lower price may be sufficiently low (i.e., less than or equal to the funds/credit remaining in the payment account) to allow the charge to the payment account to be authorized.

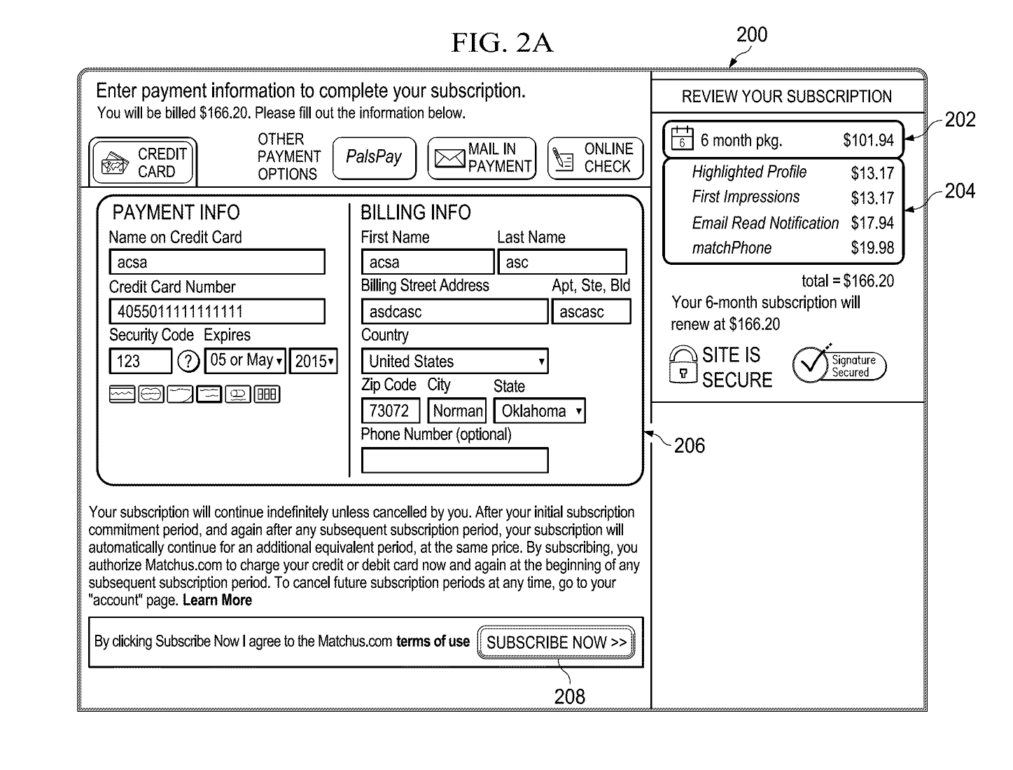

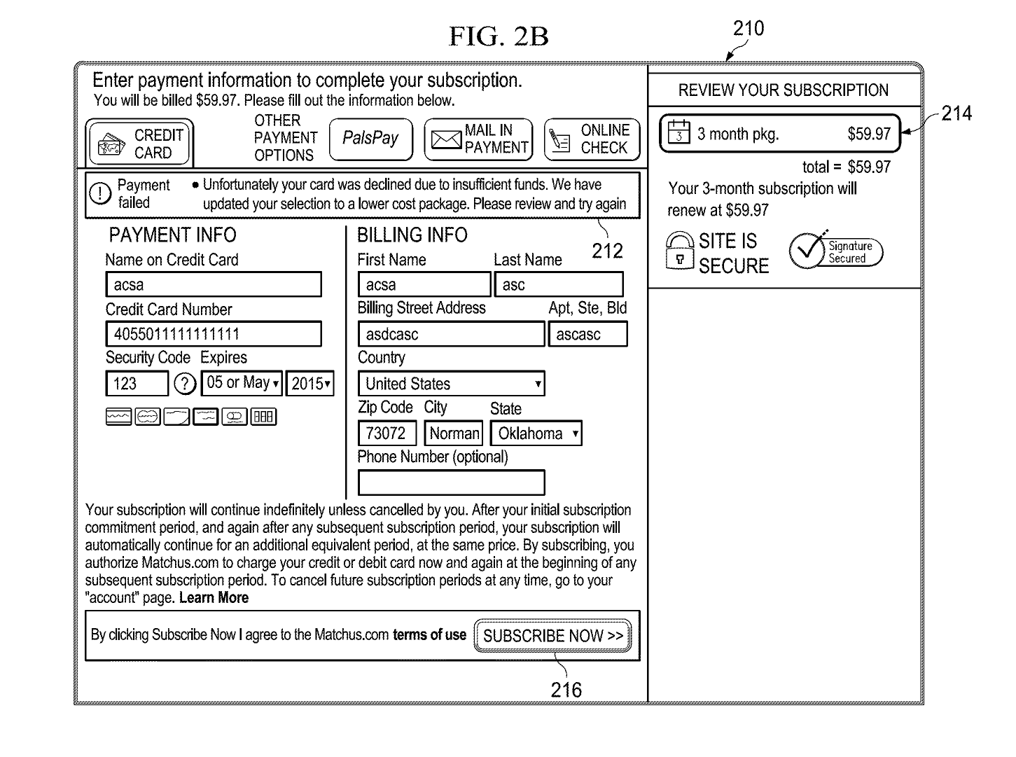

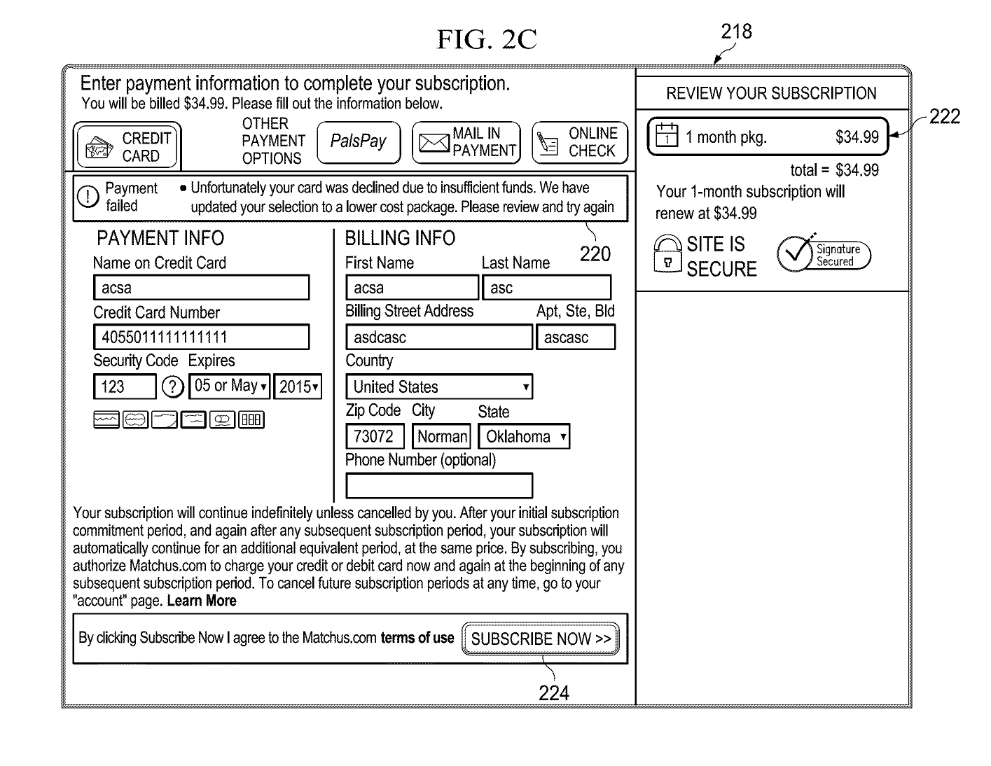

To further explain how such information in the message from the payment processor may be leveraged in generating offer(s) to an end user, FIGS. 2A-C and 3A-D are shown as illustrative screen shots to illustrate some example protocols. In these example protocols, an end user interacts with a platform through a user interface to make a purchase for a subscription to the platform. Though the user interface, an application provides offer(s) to the end user by rendering one or more screens for display to the user. The user can provide user input via/through the user interface by interacting with one or more elements on the screen. Other ways of interacting the platform are envisioned. For instance, the user interface may be an audio interface where audio messages are delivered to the user through audio output. In some embodiments, the user interface may receive, e.g., voice, gestures, etc., as inputs. Audio- and/or gesture-based user interfaces may be used in embodiments where, e.g., an end user is making a purchase over the phone, or when the user using a device in hands-free mode.

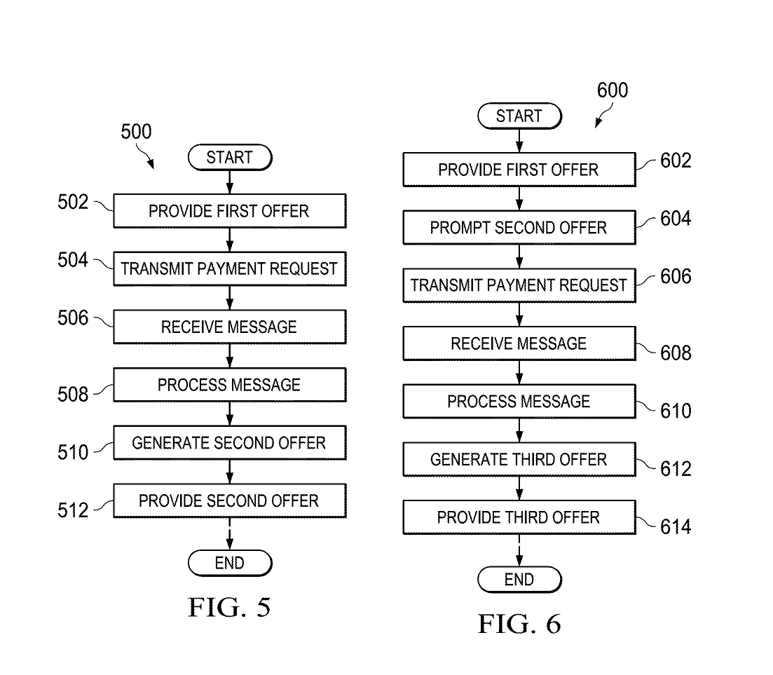

FIGS. 2A-C are simplified screen shots of an example protocol for generating and providing offer(s) to a user, according to some embodiments of the disclosure. The protocol corresponds to the exemplary method 500 shown as an illustrative flow diagram in FIG. 5. As seen in the screen shot 200 in FIG. 2A, the user interface is configured to provide a first offer having a first price (corresponding to step 502 of FIG. 5). The first offer may comprise a subscription 202 for 6 months at a price of $101.94. Optionally, the user may have selected one or more add-on's 204, including at least one of: “Highlighted Profile”, “First Impressions”, “Email Read Notification”, and “match Phone”. Each of these add-on's may have an associated price. In the example shown, the first offer comprises subscription 202 and several add-on's 204 with a total price of $166.20.

In the same screen, the user is provided with a form 206 to provide payment information through the user interface. Payment information may include information associated with a payment account of the user. Typically, the payment information includes information which identifies the payment account and optionally provides further information for verification purposes. Payment information may include at least one of: name on credit card, credit card number, type of credit card, security code, expiration month and year, first name, last name, billing address, phone number, etc. Alternatively, or additionally, a user may be prompted to confirm or select saved payment information that the application has retrieved from storage (if the user has previously provided the payment information and saved the payment information in his/her profile in storage). In some embodiments, the user may be prompted to provide credential information to a digital wallet which is configured store and provide the payment information from the digital wallet and/or maintain funds in a digital wallet from which a payment may be made.

Once the application has retrieved or received payment information for the payment account and the application has received a first user input indicating an acceptance to the offer has been received through the user interface (e.g., by clicking on “SUBSCRIBE NOW” button 208 on screen 200), the application may transmit a first request to a payment processor process a payment from the payment account of the user for the first price (corresponding to step 504 of FIG. 5). For instance, the application may transmit a payment request for, e.g., $166.20 from the payment account of the user (e.g., to an account belonging to the merchant offering the subscription to the platform). In other words, the first request to the payment processor asks for an authorization to deduct an amount of $166.20 from the funds/credit in the payment account.

It is possible that the payment account has less than $166.20 in its available funds/credit, e.g., $120.34. Due to insufficient funds, the payment processor cannot complete the first request. Due to privacy/security concerns, the administrator of the payment account (e.g., a bank, or the payment processor itself if the payment processor also manages the payment account) may not share the exact amount of available funds/credit information. Consequently, the application (or the offer engine) would not have information related to the amount of available funds/credit. However, if there is actually some available funds/credit in the account, there is an opportunity for a lower payment to be processed from the payment account of the user.

In some cases, the first message from the administrator of the payment account or the payment processor to the application would provide an error code, at least indicate that the payment request cannot be completed (corresponding to step 506 of FIG. 6, where the application receives the first message from the payment processor). The error code may correspond to an error description. More importantly, the error code may provide some indication for the type of problem which prevented the payment from being completed or processed successfully.

As seen in the screen shot 210, a first error message 212 is provided to the user to inform the user that the payment cannot be completed. In some embodiments, a specific error message may be provided to the user, which may be generated using the error code in the message from the payment processor. Depending on the error code, different error messages may be provided to the user.

In some embodiments, the application may infer from the error code in the first error message 212 that the first request could not be completed or was denied due to insufficient funds. For instance, the error code may indicate, e.g., “do not honor” or “credit floor” message, where an inference may be made that there may be insufficient funds/credit in the account. If there is some available funds/credit in the account, there is an opportunity for a lower payment to be processed from the payment account of the user. To capture this opportunity, the application and an offer engine are configured to generate and provide a second offer having a second price that is lower than the first price based on the error message received from the payment processor.

Suppose the first request for payment in response to the first offer could not be completed due to insufficient funds, it is possible that the payment account may (actually) have sufficient funds for a second offer associated with a second price, wherein the second price is lower than the first price. Accordingly, the first error message can be processed (corresponding to step 508 in FIG. 5) to generate a second offer with a second price (corresponding to step 510 of FIG. 5) to provide the user with another opportunity to make a purchase (corresponding to step 510 of FIG. 5).

An offer engine may be provided to process the messages and/or the error codes in the message from the payment processor, e.g., if the payment request cannot be completed. Typically, the message may include one or more error codes, and a subset of which may indicate that there are insufficient funds/credit in the payment account (while others may indicate that the payment cannot be completed due to other types of problems). If the offer engine determines that the error code indicate there are insufficient funds/credit, the offer engine may then generate a second offer with a lower price.

For instance, an error code may be extracted from the first message, or the error code may be retrieved from the first message. The offer engine may determine from the error code whether the error code indicates there is insufficient funds/credit in the payment account. A look-up table, or any suitable data structure or logic function, may be used for such determination. For instance, a look-up table in storage may comprise error codes with corresponding indicators indicating whether an error code indicates there is insufficient funds/credit in the payment account. The offer engine may determine, e.g., using the look-up table, whether the error code matches one or more of the error codes which may indicate insufficient funds/credit.

If it is determined that the error code does indicate insufficient funds/credit, the offer engine may generate a second offer having a second price. If the first offer having a first price may include a first subscription with a first duration and optionally one or more add-on's, the second offer may have a subscription with a second duration shorter than the first duration and a second price lower than the first price when compared with the first offer. In some embodiments, the second offer may have no or less add-on's when compared with the first offer (while the second duration remains the same as the first duration). In certain embodiments, the second offer may have a subscription with a shorter duration and no/less add-on's when compared to the first offer (as well as a lower price). As shown in screen shot 210 in FIG. 2B, a second offer 214 is provided to the user through the user interface. For instance, when a first offer comprises a 6-month subscription with several add-on's as seen in screen shot 200, a second offer 214 may be provided with a subscription for 3 months (and no add-on's) at a price of $59.97. The user may be optionally informed through error message 220 that the shopping cart has been updated with a lower cost package.

While it is beneficial to generate the second offer to capture another opportunity for the user to make a purchase at a lower price, the offer engine may not generate the second offer at the first instance an error message indicating insufficient funds/credit is received. In some embodiments, the offer engine may generate the second offer only after the user has attempted to purchase the first offer but failed at the second time, third time, or fourth time, and so on (i.e., further request(s) for payment to purchase the same offer are sent and the payment processor transmits further message(s) indicating further request(s) for payment cannot be completed). The offer engine may process the plurality of error messages received at the first instance, second instance, and so on, and log the number of times a payment request to purchase the first offer is responded with an error message indicating insufficient funds. Accordingly, the offer engine can generate the second offer when the number of times a payment request to purchase the first offer is rejected (for insufficient funds/credit) reaches a threshold. This provides a buffer to allow the user to attempt to make a payment again for the same offer having the same price before an offer with a lower price is generated.

In some embodiments, the payment information provided through screen 200 is saved for the session. In some other embodiments, the user may provide or confirm the payment information using the user interface. When the application has received another user input indicating an acceptance to the second offer has been received through the user interface (e.g., by clicking on “SUBSCRIBE NOW” button 216 on screen 210), the application may transmit a second request to the payment processor to process a payment for $59.97 from the payment account of the user identified by the payment information (e.g., to an account belonging to the merchant offering the subscription to the platform). In other words, the second request to the payment processor asks for an authorization to deduct an amount of $59.97 from the funds/credit in the payment account.

If a second message indicating the second request for payment was completed successfully is received from the payment processor, the application informs the user that the purchase has been successfully completed. For instance, a message may be displayed to the user indicating that the purchase has been successfully completed and a payment of an amount of $59.97 has been processed successfully.

It is possible that the payment account has less than $59.97 in its available funds/credit, e.g., $45.50. Due to insufficient funds, the payment processor cannot complete the request. Due to privacy/security concerns, the administrator of the payment account (e.g., a bank, or the payment processor itself if the payment processor also manages the payment account) may not share the exact amount of available funds/credit information. Consequently, the application would not have information related to the amount of available funds/credit. However, a message from the administrator of the payment account or the payment processor would be provided to at least indicate that the payment request cannot be completed.

For similar reasons as explained above, it may be possible to capture an opportunity to provide an offer to the user at an even lower price (the arrow with a dotted line in FIG. 5 denotes that the method 500 may continue for one or more iterations the method steps). Depending on the error message, different error messages may be provided to the user. In some embodiments, the application may infer from the error code that the request could not be completed or was denied due to insufficient funds. For instance, the error code may indicate, e.g., “do not honor” or “credit floor” message, where an inference may be made that there may be insufficient funds in the account.

If a second message indicating that the second request for payment indicating that the second request cannot be completed is received from the payment processor, the second message is processed by an offer engine to generate a third offer having a third price, wherein the third price is lower than the first price and the second price. The price for each offer is successively decreased, and the user is provided with yet another opportunity to make a purchase. The successive process of generating offers with a lower price (e.g., by decreasing the duration of a subscription and/or removing items or add-on's of an offer) may continue until no offers with a lower price is available to be made. In some embodiments, the successive process may continue until a condition is met, e.g., no further offers having a lower price is available, or a certain maximum number of iterations has been performed. In some embodiments, the successive process of generating further offers may depend on other factors such as user profile information, or the number of times an error message has been received from the payment processor.

To process the second message received from the payment processor, an error code may be extracted from the second message, or the error code may be retrieved from the second message. The offer engine may determine from the error code whether the error code indicates there is insufficient funds/credit in the payment account. A look-up table, or any suitable data structure or logic function, may be used for such determination. For instance, a look-up table in storage may comprise error codes with corresponding indicators indicating whether an error code indicates there is insufficient funds/credit in the payment account. The offer engine may determine, e.g., using the look-up table, whether the error code matches one or more of the error codes which may indicate insufficient funds/credit. A detailed error message (e.g., message 220 in screen shot 218 of FIG. 2C) may be provided to the user to inform the user that there may be insufficient funds in the payment account, and optionally inform the user that the shopping cart has been updated with a different offer (e.g., a lower cost package).

If it is determined that the error code does indicate sufficient funds/credit, the offer engine may generate a third offer having a third price (if an offer with an even lower price is available). The generation of the third offer may be done in a similar manner as generating the second offer. As shown in screen shot 218 in FIG. 2C, a third offer 222 is provided to the user through the user interface. For instance, when a second offer 214 comprises a 3-month subscription as seen in screen shot 210, a third offer 222 may be provided with a subscription for 1 month (and no add-on's) at a price of $34.99.

Generation of offers by processing the (error) message from the payment processor may be done in several ways. In one embodiment, the error code is used to determine whether there may be insufficient funds/credit in the payment account (thereby causing to an error in completing the payment request). If the error code correspond to an error code which indicates there is insufficient funds/credit, a second offer (or a next offer) may be selected from a list of offers which has a price lower than the first price of the first offer (or a price of a previous offer). The list of offers may be an ordered list of potential offers in the order from the highest price to the lowest price. Any offer in the list that has a lower price may be selected from the ordered list. An offer will not be generated if there are no other offers remaining in the ordered list with an even lower price. In one embodiment, the generation of offers is made using defined rules (rules may be stored in a storage). The defined rules may be applied to a previous offer to systematically generate a next offer which has a lower price. Defined rules may, decrement the size of the offer (e.g., decrease the duration of a subscription, decrease the amount of virtual currency being purchased, etc.). Some defined rules may remove item(s) and/or add-on(s) from the offer to decrease the price of the offer. In some embodiments, defined rules may replace previous item(s) and/or add-on(s) with a different set of item(s) and/or add-on(s) that have a lower price in order to generate another offer with a lower price than the previous offer. It is envisioned that a combination of ordered lists and rules may also be used in some embodiments.

In some embodiments, the offer engine may store a history of error messages, or keep count for one or more types of error messages. The history of error messages may be used in generating the next offer. In one instance, the generation of the next offer having a lower price may depend on whether a sufficient number of error messages indicating insufficient funds/credit has been received (for the same offer having the same price) to provide a buffer before the next offer is provided to the user. In another instance, if the application has received not just one, but two (or more) messages from the payment processor for a particular user over a period of time, e.g., for different offers having different prices, indicating that the payment request cannot be completed due to insufficient funds, it may be inferred that there may be very little available funds/credit on the payment account. The offer engine may generate an offer with a price that is substantially lower than the previous offer (e.g., the price may decrease at a higher/faster rate than the situation where the history of error messages does not affect how the offer is generated). For instance, if messages indicating insufficient funds has been received for payments towards a 12-month subscription and a 6-month subscription, the next offer may be generated for a 1-month subscription (instead of a 3-month subscription). The price of the offer may be decreased more aggressively/significantly when the number of times a message indicating insufficient funds is received increases.

In some embodiments, the offer engine may store profile information of users which may indicate or suggest how likely the payment account of a user has insufficient funds. For instance, the age of the user may be used to generate offers differently for various age groups. Various age groups may, in general, have different amounts of credit card debt. The offer engine may decrease the price for the next offer more aggressively for users who are within the 45-65 age group when compared to users who are within the 35-45 age group. Similarly, the offer engine may decrease the price for the next offer more aggressively for users who are within the 25-35 age group when compared to users who are within the 35-45 age group. Other types of profile information may be used to generate offers differently. For instance, if the user has provided the information that he/she is currently attending school, the offer engine may decrease the price for this user more aggressively. In another instance, the offer engine may decrease the price for women users more aggressively. It is envisioned that profiles may be defined for one or more classes of users, such that the offer engine may generate the next offer in a way that is tailored to these classes.

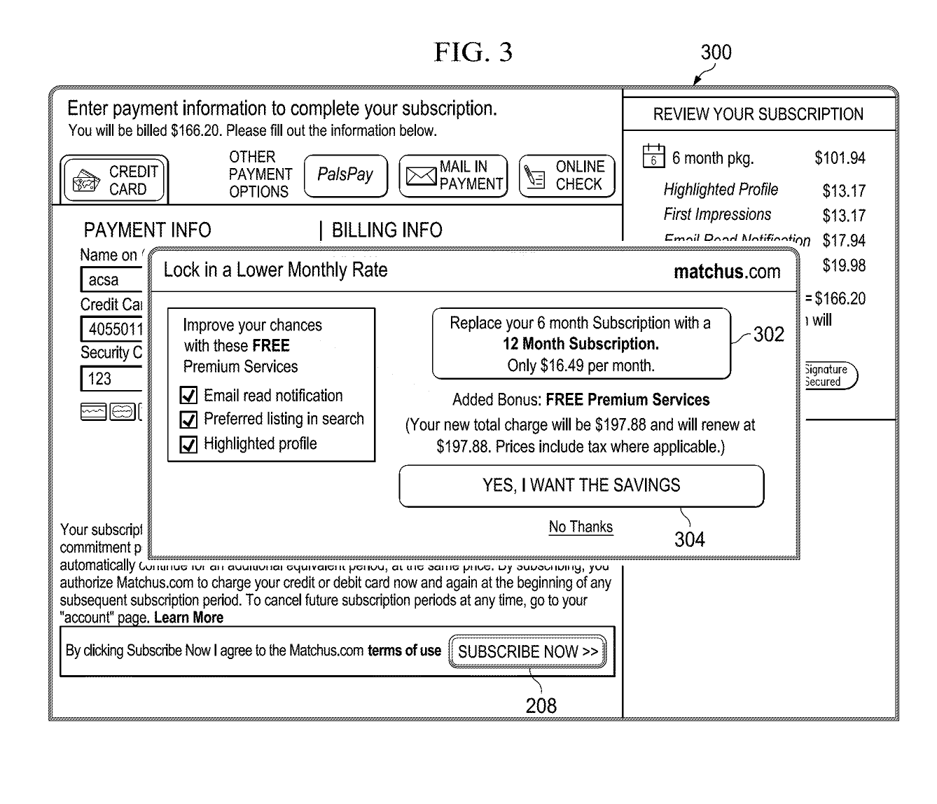

FIG. 3 shows a simplified screen shot from another example protocol for generating and providing offer(s) to a user, according to some embodiments of the disclosure. The protocol corresponds to the exemplary method 600 shown as an illustrative flow diagram in FIG. 6. While offers may be generated to have a lower price than the previous offer, it is also envisioned that some embodiments may prompt a user to accept an offer with a higher price before offers with a lower price are generated.

A user may be provided with a first offer having a first price (corresponding to step 602 in FIG. 6). User input is received to accept the first offer. Prior to submitting a request to a payment processor to process the payment for first price, the user may be prompted by the application through the user interface with an offer that has a higher price than the first price (corresponding to step 604 in FIG. 6 of prompting a second offer). The offer engine may generate the offer with a higher price to capture an opportunity for the user to purchase an offer that has a higher price. A user input is received in response to that higher priced offer through the user interface. If the user input indicates an acceptance for the higher priced offer, a payment request is submitted to the payment processor for the higher price rather than the first price (corresponding to step 606 in FIG. 6). If the user input indicates a refusal to the higher priced offer, then the payment request is submitted according to the first price. The application may then receive a message in response to the payment request (corresponding to step 608 in FIG. 6). The process then continues as described for FIGS. 2A-C, where messages from the payment processor are processed (corresponding to step 610 of FIG. 6) to determine whether the messages (or the error codes in these messages) indicate insufficient funds and offers with a lowered price may be generated (corresponding to step 612 of FIG. 6) and provided to the user through the user interface (corresponding to step 614 of FIG. 6). For instance, if the request for payment for the higher price cannot be completed and a message from the payment processor is received indicating that the payment account may have insufficient funds/credit, the process may continue on to generate a lower priced offer (as denoted by an arrow with a dotted line in FIG. 6, further iterations of the method steps may be performed to successively generate lower priced offer(s)).

As seen in FIG. 3, a user may have provided user input to the application accepting a first offer for a 6-month package at a price of $119.94. Prior to transmitting a request to the payment processor for an amount of $119.94, the offer engine may generate a higher priced offer to the user. The higher priced offer 302 as seen in screenshot 300 may include a 12-month subscription at a price of $16.49 per month with a total price of $197.88. The higher priced (optionally with an added bonus “FREE Premium Services”). The user may accept the offer using a button “YES, I WANT THE SAVINGS” 304 to accept the higher priced offer, or alternatively refuse the offer by selecting “No Thanks”. Advantageously, the generation and prompting of the higher priced offer captures the opportunity for the user to make a purchase having a higher price.

Similar to generating offers with lower prices, the offer engine may generate the higher priced offer based on a history of messages from the payment processor for the particular user and/or user profile information for that particular user. It is possible that some users may be more likely to have a higher amount of funds/credit in the payment account than other users. Thus, the option of generating the higher priced offer may be exercised for those users only. In some cases, the offer engine may generate a higher priced offer with a greater price difference between the high priced offer and the first offer for some users versus other users.

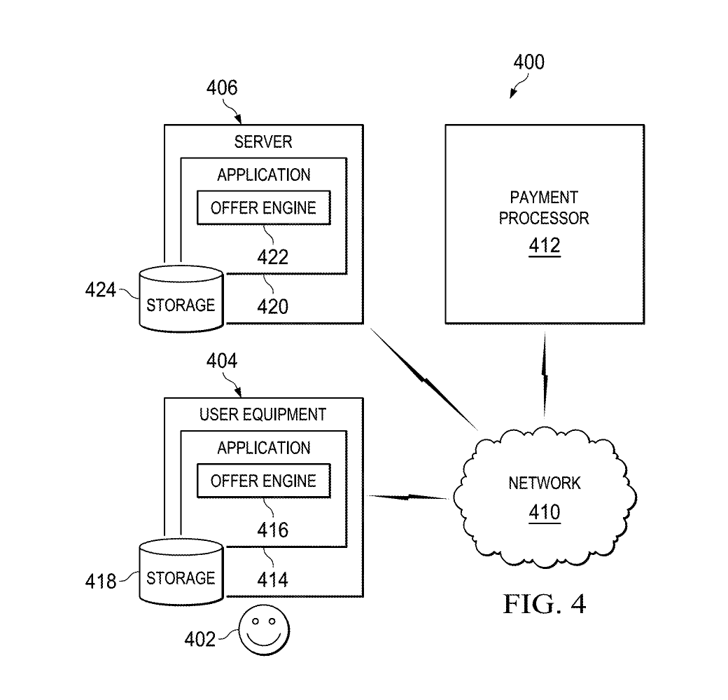

FIG. 4 is a system diagram showing an illustrative system configured generate and provide offers(s), according to some embodiments of the disclosure. The system for providing offers to a user may be performed in different ways. In one embodiment, a user 402 uses user equipment 404. An application 414 (e.g., online dating application, online shopping application, gaming application, etc.) may be implemented on the user equipment. A user interface is also provided on the user equipment to allow the user to interact with the application. Furthermore, an offer engine 416 for generating offers may be provided in user equipment 404. In some embodiments, the application 414 and the offer engine 416 may be implemented as a single application. In some other embodiments, the application and the offer engine may be implemented as a plurality of applications. In yet some embodiments, the functions of the application and the offer engine are mixed/shared.

A storage 418 (e.g., computer-readable non-transient memory) may be provided with the user equipment to store any program instructions to perform the functions disclosed herein. The storage 418 may also be used for storing, e.g., possible offers, history of messages/error codes from the payment processor, look-up tables, rules for generating offers, etc. A payment processor 412 may be provided as a remote server communicably connected to the user equipment 404 over communication network 410.

In some embodiments, the application 414 on user equipment 404 may cooperate with an application 420 in a server 406 that is communicably connected with the user equipment 404 over a communication network 410 (e.g., the Internet), e.g., in a client-server model. Requests to payment processor 412 may be sent from the application 420 in server 406. In certain embodiments, at least a part or the entire offer engine may be implemented on the server 406 as offer engine 422, which may be configured to process messages sent from the payment processor to generate subsequent offers. A storage may be provided 424 for carrying similar functions as storage 418. The offer engine 422 implemented at least partially on a server may advantageously allow rules and/or look-up tables used for generating offers to be updated and/or optimized in a centralized location.

Note that in certain example implementations, the methods/functions outlined herein, such as those carried out by web server 16 and/or provided as an application for an endpoint being operated by an end user (e.g., a mobile application for an iPhone™), may be implemented by logic encoded in one or more non-transitory, tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory, as shown in FIG. 1, can store data used for the operations described herein. This includes the memory being able to store software, logic, code, or processor instructions that are executed to carry out the activities described in this Specification.

A processor can execute any type of instructions associated with the data to achieve the operations detailed herein in this Specification. In one example, the processor, as shown in FIG. 1, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

These devices illustrated herein may maintain information in any suitable memory or storage (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory” or “storage.” Similarly, any of the potential processing elements, modules, and machines described in this Specification should be construed as being encompassed within the broad term “processor.” Each of the network elements can also include suitable interfaces for receiving, transmitting, and/or otherwise communicating data or information in a network environment.

Note that with the example provided above, as well as numerous other examples provided herein, interaction may be described in terms of more than one network element. However, this has been done for purposes of clarity and example only. In certain cases, it may be easier to describe one or more of the functionalities of a given set of flows by only referencing a limited number of network elements. It should be appreciated that system 10 (and its teachings) are readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the steps in the preceding flow diagrams illustrate only some of the possible signaling scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure. Although the present disclosure has been described in detail with reference to particular arrangements and configurations, these example configurations and arrangements may be changed significantly without departing from the scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method for providing offers to a user through a user interface, comprising:
providing a first offer having a first price to a user through the user interface;
receiving a first user input indicating an acceptance to the first offer through the user interface;
transmitting a first request to a payment processor to process a first payment from a payment account of the user for the first price;
receiving a first message from the payment processor in response to the first request indicating that the first request cannot be completed;
processing the first message to generate a second offer having a second price, wherein the second price is lower than the first price; and
providing the second offer to the user through the user interface.

2. The method according to claim 1, further comprising:
receiving a second user input indicating an acceptance to the second offer through the user interface;
transmitting a second request to a payment processor to process a second payment from the payment account of the user for the second price;
receiving a second message from the payment processor in response to the second request that the second request cannot be completed;
processing the second message to generate a third offer having a second price, wherein the third price is lower than the first price and the second price; and
providing the third offer to the user through the user interface.

3. The method according to claim 1, further comprises:
prior to transmitting the first payment request to the payment processor:
prompting the user with a third offer having a third price through the user interface, wherein the third price is higher than the first price;
receiving a third user input through the user interface in response to the third offer;
if the third user input indicates an acceptance to the third offer, transmitting the first payment request to the payment processor for the third price instead of the first price; and
if the third user input indicates a refusal to the third offer, continue with the step of transmitting the first payment request to the payment processor for the first price.

4. The method according to claim 1, wherein:
the first offer comprises a first subscription for a first duration; and
the second offer comprises a second subscription for a second duration, wherein the second duration is shorter than the first duration.

5. The method according to claim 1, wherein:
the first offer is a bundle comprising a first subscription for a first duration and one or more add-on products; and
the second offer comprises a second subscription for a second duration and no add-on products, wherein the second duration is shorter than the first duration.

6. The method according to claim 1, further comprising:
receiving payment information from the user through the user interface and/or retrieving payment information from profile of the user from computer-readable non-transient memory, wherein the payment information comprises information identifying the payment account.

7. The method according to claim 1, wherein the first message from the payment processor indicates insufficient funds in the payment account.

8. The method according to claim 2, wherein the second message from the payment processor indicates insufficient funds in the payment account.

9. The method according to claim 1, wherein the first message comprises an error code corresponding to a “do not honor” or a “credit floor” message.

10. The method according to claim 1, wherein:
processing the first message comprises:
receiving or extracting an error code from the first message; and
determining, from a look-up table, whether the error code indicates insufficient funds in the payment account, wherein the look-up table comprises error codes with corresponding indicators indicating whether an error code indicates insufficient funds;
generating the second offer having the lower price if the error code indicates insufficient funds in the payment account.

11. One or more non-transitory computer-readable media that includes code for execution and when executed by one or more processors is operable to perform operations for providing offers to a user through a user interface, the operations comprising:
providing a first offer having a first price to a user through the user interface;
receiving a first user input indicating an acceptance to the first offer through the user interface;
transmitting a first request to a payment processor to process a first payment from a payment account of the user for the first price;
receiving a first message from the payment processor in response to the first request indicating that the first request cannot be completed;
processing the first message to generate a second offer having a second price, wherein the second price is lower than the first price; and
providing the second offer to the user through the user interface.

12. The one or more non-transitory computer-readable media according to claim 11, wherein:
the first offer comprises a first subscription for a first duration; and
the second offer comprises a second subscription for a second duration, wherein the second duration is shorter than the first duration.

13. The one or more non-transitory computer-readable media according to claim 11, wherein the first message from the payment processor indicates insufficient funds in the payment account.

14. The one or more non-transitory computer-readable media according to claim 11, wherein the first message comprises an error code corresponding to a “do not honor” or a “credit floor” message.

15. The one or more non-transitory computer-readable media according to claim 11, wherein:
processing the first message comprises:
receiving or extracting an error code from the first message; and
determining, from a look-up table, whether the error code indicates insufficient funds in the payment account, wherein the look-up table comprises error codes with corresponding indicators indicating whether an error code indicates insufficient funds;
generating the second offer having the lower price if the error code indicates insufficient funds in the payment account.

16. A computer system for providing offers to a user, comprising:
a storage for storing computer program instructions;
one or more processors for executing the computer program instructions for providing an application for receiving one or more user inputs from the user through a user interface, the application configured for
providing a first offer having a first price to a user through the user interface;
receiving a first user input indicating an acceptance to the first offer through the user interface;
transmitting a first request to a payment processor to process a first payment from a payment account of the user for the first price;
receiving a first message from the payment processor in response to the first request that the first request cannot be completed;
the one or more processors for executing the computer program instructions further for providing an offer engine communicably connected to the application, said offer engine configured for processing the first message to generate a second offer having a second price, wherein the second price is lower than the first price;
wherein the application is further configured to provide the second offer to the user through the user interface.

17. The computer system according to claim 16, wherein the offer engine is at least partially implemented in a server, the server being communicably connected to the user interface via a communication network.

18. The computer system according to claim 16, wherein the payment processor is communicably connected to the application via a communication network.

19. The computer system according to claim 16, wherein the first message from the payment processor indicates insufficient funds in the payment account.

20. The computer system according to claim 16, wherein:
processing the first message using the offer engine:
receiving or extracting an error code from the first message; and
determining, from a look-up table, whether the error code indicates insufficient funds in the payment account, wherein the look-up table comprises error codes with corresponding indicators indicating whether an error code indicates insufficient funds
generating the second offer having the lower price if the error code indicates insufficient funds in the payment account.
